(19) United States
(12) Patent Application Publication
(10) Pub. No.: US 2015/0314318 A1
(43) Pub. Date: Nov. 5, 2015

(54) THERMAL BREAK FOR HOT MELT SYSTEM FLUID LINE

(71) Applicant: GRACO MINNESOTA INC., Minneapolis, MN (US)

(72) Inventors: Corey D. Johnson, Akron, OH (US); John S. Lihwa, Peninsula, OH (US); Paul R. Quam, Brooklyn Center, MN (US); Steven R. Sinders, North Canton, OH (US); J. Shawn Oakes, Cuyahoga Falls, OH (US)

(21) Appl. No.: 14/443,449

(22) PCT Filed: Nov. 18, 2013
(86) PCT No.: PCT/US2013/070513

§ 371 Date: May 18, 2015

Related U.S. Application Data
(60) Provisional application No. 61/728,053, filed on Nov. 19, 2012.

(51) Int. Cl. B05C 5/00; B05C 11/10

(52) U.S. Cl. CPC B05C 5/001; B05C 11/1002

(57) ABSTRACT

Systems and methods of dispensing a hot melt adhesive material that can be heated from a lower temperature flowable non-molten liquid state to a higher temperature molten liquid state, the systems and methods comprise: pumping with a pump the hot melt adhesive material in the lower temperature flowable non-molten liquid state into a supply conduit; passing the hot melt adhesive material through a heated thermal break in the supply conduit that allows free flowing movement of transitional non-molten and molten state material; heating the hot melt adhesive material in a heat exchanger connected to the heated thermal break to the higher temperature molten liquid state; and dispensing the hot melt adhesive material in the higher temperature molten liquid state from a dispenser in fluid communication with the heat exchanger.

### BACKGROUND

The present disclosure relates generally to systems for dispensing liquid hot melt adhesive. More particularly, the present disclosure relates to a fluid line for connecting components within a hot melt dispensing system. For example, a fluid line may be used to connect a pump with a heat exchanger for a hot melt adhesive dispenser.

Liquid hot melt dispensing systems are typically used in manufacturing assembly lines to automatically disperse an adhesive used in the construction of packaging materials such as boxes, cartons and the like. Liquid hot melt adhesive dispensing systems utilize glue, such as hybrid plastisols and the like, that are highly viscous liquids at room temperature, but that become activated by heat to become a lower viscosity molten liquid. The molten liquid is easier to pump and dispense once being heated. However, the molten liquid cannot be exposed to prolonged heating without charring. As such, it becomes important for liquid hot melt systems to activate the liquid hot melt adhesive as close as possible to the dispense point to reduce waste.

A typical liquid hot melt adhesive dispensing system comprises a pump and a dispenser, between which is positioned a heater in close proximity to the dispenser. Such a system is described in U.S. Pat. No. 7,623,772 to Stumphauzer et al. Challenges arise, however, in removing molten liquid that solidified between the heater and the pump after the dispensing system is shut-down, such as for maintenance. Furthermore, molten liquid can migrate upstream, such as via thermal expansion, to an unheated portion of the system and begin to solidify into a plug. At some point, the plug can solidify to completely block flow of molten liquid.

### SUMMARY

A method of dispensing a hot melt adhesive material, the method comprising: pumping a hot melt adhesive material in a lower temperature flowable non-molten liquid state into a supply conduit; passing the hot melt adhesive material through a heated thermal break in the supply conduit that allows free flowing movement of transitional non-molten and molten state material; heating the hot melt adhesive material in a heat exchanger connected to the heated thermal break to a higher temperature molten liquid state; and dispensing the hot melt adhesive material in the higher temperature molten liquid state from a dispenser in fluid communication with the heat exchanger.

A dispensing system for hot melt material, the dispensing system comprises a pump, a fluid line, a heat exchanger, a heated thermal break and a dispenser. The pump pumps hot melt adhesive material in a non-molten liquid state. The fluid line receives hot melt material from the pump. The heat exchanger heats the hot melt adhesive to a molten liquid state. The heated thermal break is disposed in the fluid line proximate the heat exchanger to allow free flowing movement of transitional non-molten liquid state and molten liquid state material before entering the heat exchanger. The dispenser receives molten liquid state hot melt material from the heat exchanger.

### BRIEF DESCRIPTION OF THE DRAWINGS

FIG. 1 is a schematic view of a system for dispensing liquid hot melt adhesive including a pump, a fluid line having a heat break and a heated dispenser.

FIG. 2 is a schematic of the fluid line connecting the pump and heated dispenser of FIG. 1 illustrating a re-melting zone in the heat break.

### DETAILED DESCRIPTION

The present invention provides a heated thermal break for a fluid line connecting a fluid pump and a heat exchanger coupled to a dispenser. The heat exchanger activates a material, such as a hot melt adhesive, by subjecting the material to a sufficient heat level. The heated thermal break prevents heated and activated material from the heat exchanger that migrates upstream due to thermal expansion from solidifying in the fluid line beyond the thermal reach of the heat exchanger.

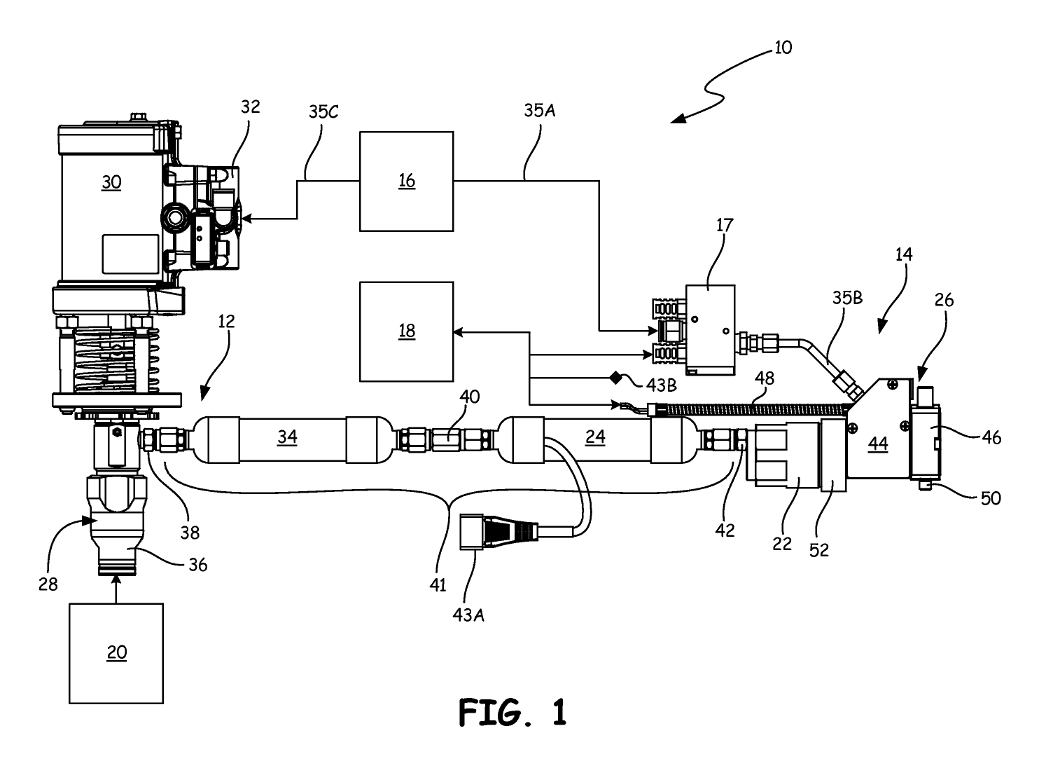

FIG. 1 is a schematic view of system 10, which is a system for dispensing liquid hot melt adhesive. System 10 includes cold section 12, hot section 14, air source 16, air control valve 17, controller 18 and container 20. In the embodiment shown in FIG. 1, hot section 14 includes heat exchanger 22, thermal break 24, and dispenser 26, and cold section 12 includes pump 28, air motor 30, air valve 32 and cold line 34. System 10, for example, can be part of an industrial process for packaging and sealing cardboard packages and/or cases of packages. In alternative embodiments, system 10 can be modified as necessary for a particular industrial process application.

Air source 16 is a source of compressed air that supplies compressed air to components of system 10 in both cold section 12 and hot section 14. Air control valve 17 is connected to air source 16 via air hose 35A, and selectively controls air flow from air source 16 through air hose 35B to dispenser 26. Air valve 32 is connected to air source 16 via air hose 35C, and selectively controls air flow from air source 16 to motor 30. Controller 18 is in communication with various components of system 10, such as air control valve 17, heat exchanger 22 and thermal break 24, for controlling operation of system 10.

Components of cold section 12 can be operated at room temperature, without being heated. Container 20 is a vessel containing a quantity of liquid non-molten hot melt adhesive for use by system 10. Suitable adhesives can include, for example, a hybrid plastisol described in U.S. Pat. No. 7,772,313 to Stumphauzer et al. Container 20 is coupled to inlet 36 of pump 28. Motor 30 drives pump 28 to provide pressurized hot melt adhesive to outlet 38. In one embodiment, motor 30 comprises a reciprocating air motor that drives a piston within pump 28.

Outlet 38 is coupled to cold line 34, which connects to thermal break 24 at coupling 40. Cold line 34 and thermal break 24 together form fluid line, or conduit, 41 that joins outlet 38 of pump 28 to inlet 42 of heat exchanger 22. Thermal break 24 is connected to controller 18 via coupling 43A, which is shown schematically for connecting to coupling 43B. Flowable, non-molten liquid hot melt adhesive enters heat exchanger 22 and is heated to a temperature that transforms, or activates, the adhesive into a molten liquid, which reduces the viscosity of the hot melt adhesive. Heat exchanger 22 is connected via mixer 52 to dispenser 26, which includes manifold 44 and module 46. Heat exchanger 22 and module 46 are connected to controller 18 through wiring extending through conduit 48.

Molten liquid hot melt adhesive from pump 28 is received in manifold 44 and dispensed via dispensing module 46. Mixer 52 ensures that the constituent components of the hot melt adhesive material are evenly dispersed within the fluid. Dispenser 26 can selectively discharge hot melt adhesive whereby the hot melt adhesive is sprayed out of outlet 50 of module 46 onto an object, such as a package, a case, or another object benefiting from hot melt adhesive dispensed by system 10. Module 46 may include an electrically or pneumatically activated valve that receives power from conduit 48 or air hose 35B. Module 46 can be one of multiple modules that are part of dispenser 26. In an alternative embodiment, dispenser 34 can have a different configuration, such as a handheld gun-type dispenser. Some or all of the components in hot section 14, including manifold 44 and module 46, can be heated to keep the hot melt adhesive in a liquid state throughout hot section 14 during the dispensing process.

Materials dispensed by system 10 are highly viscous, flowable liquids at room temperatures, but are low viscosity, molten liquids when activated at elevated temperatures, often as high as 300° Fahrenheit (˜149° Celsius). Heat exchanger 22 imparts enough thermal energy to the material to activate the material into a molten liquid that is more easily dispensed at dispenser 26. In one embodiment, heat exchanger 22 may comprise a device as is described in the aforementioned U.S. Pat. No. 7,623,772 to Stumphauzer et al. Once the material is activated, it will solidify into a solid after retreating from the activation temperature. As such, the molten liquid hot melt adhesive must be heated at all times or it will solidify and block-up system 10. Heat exchanger 22 is positioned in close proximity to dispenser 26 to minimize the need for heating of the molten liquid hot melt adhesive.

Due to thermal expansion that occurs in the material, it is possible for activated liquid hot melt adhesive to migrate upstream from heat exchanger 22 toward pump 28. Because pump 28 is located in cold section 12 of system 10, the molten liquid hot melt adhesive will eventually solidify after transitioning through a molten and non-molten mixed state. The solidified material will form a plug that, at first, reduces pressure to dispenser 26 and decreases shot size of dispenser 26, thereby decreasing consistency of system 10. Eventually, the plug will grow to block flow to dispenser 26 altogether. Heated thermal break 24 provides a heated buffer between pump 28 and heat exchanger 22 to maintain heating of any activated, molten liquid hot melt adhesive that migrates upstream of heat exchanger 22.

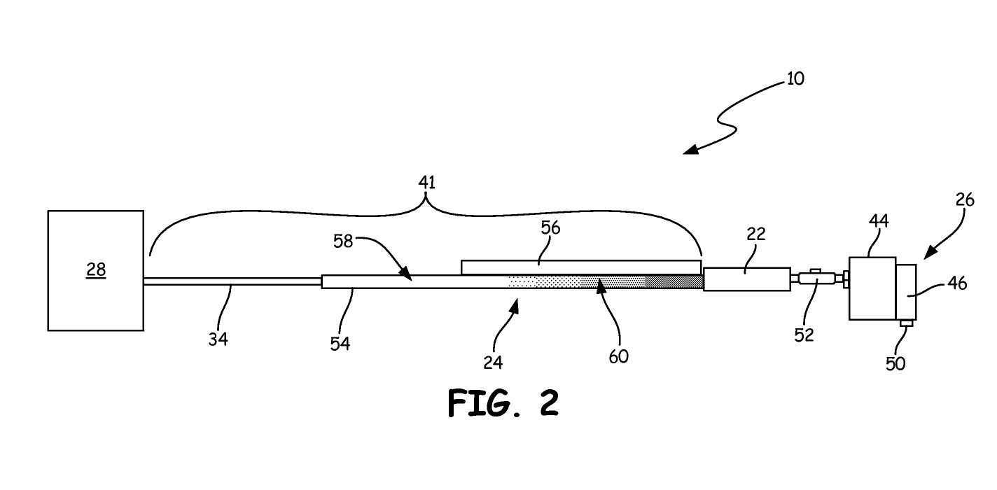

FIG. 2 is a schematic of fluid line 41 of system 10 of FIG. 1 showing heated thermal break 24 positioned between pump 28 and heat exchanger 22. Heat exchanger 22 is connected to manifold 44 and module 46 of module 26 via mixer 52. Pump 28, heat exchanger 22 and dispenser 26 are configured to operate the same as in FIG. 1. Thermal break 24 includes conduit 54 and heating device 56, which results in conduit 54 having un-heated section 58 and heated section 60.

As discussed earlier, pump 28 provides flowable, room temperature, un-activated liquid hot melt adhesive to fluid line 41 and heat exchanger 22. Heat exchanger 22 imparts thermal energy to the liquid hot melt adhesive to raise the temperature of the liquid hot melt adhesive to an activation temperature. The activation temperature melts and fuses the constituent components of the liquid hot melt adhesive into a molten liquid hot melt adhesive. Mixer 52 ensures that the constituent components are fully melted and blended into homogeneous glue. Manifold 44 receives the molten liquid and provides it to one or more of modules 46, which dispense the molten liquid at outlets 50.

Ideally, as system 10 operates, all activated molten liquid hot melt adhesive progresses through system 10 and leaves at outlet 50. Thus, all molten liquid hot melt adhesive that solidifies when the temperature decreases past the activation temperature, such as when system 10 is shut-down, would be contained in heated components of system 10, such as heat exchanger 22, mixer 52 and dispenser 26, in hot section 12 (FIG. 1). Upon start-up of system 10, the solidified hot melt adhesive can be melted by the heated components. However, due to thermal expansion of the molten liquid hot melt adhesive, activated liquid hot melt adhesive can travel from heat exchanger 22 toward pump 28 within fluid line 41. Without the use of heated thermal break 24, this activated liquid hot melt adhesive will eventually solidify in cold section 14 (FIG. 1) potentially causing problems at shut-down and during dispensing operations, as previously discussed.

Heated thermal break 24 is connected into fluid line 41 to provide a heating zone of sufficient temperature and length that facilitates controlled re-melting of any solidified or semi-solidified material. Heating device 56 extends along a portion of conduit 54 to provide heating that forms a temperature gradient (as illustrated in FIG. 2) between heat exchanger 22 and unheated section 58. Activated molten liquid hot melt adhesive from heat exchanger 22 will migrate upstream into conduit 54 of thermal break 24, all the way through heated section 60 and into unheated section 58. The molten liquid hot melt adhesive will cool the further away it gets from heated section 60 and heating device 56, turning into a non-molten and molten transitional state material.

The transitional state material will form into a plug having a diameter smaller than that of conduit 54 in unheated section 58. The pressure of pump 28 pushes the plug back towards heat exchanger 22 through heated section 60. Heated thermal break 24, specifically heated section 60, allows the plug to move freely within fluid line 41 before entering heat exchanger 22. Unheated section 58 provides a runway that allows the plug to more freely enter heated section 60. Thus, the lengths of unheated section 58 and heated section 60, the diameters of unheated section 58 and heated section 60, the materials of unheated section 58 and heated section 60, and the amount and location of heat from heating device 56 can all be selected to control the formation and remelting of plugs within fluid line 41 to thereby mitigate the risk of a plug interfering with free flow of material through system 10.

In one embodiment, heated section 60 and unheated section 58 have the same inside diameter as each other, thereby allowing the plug to be easily pushed through thermal break 24. In one particular embodiment, heated section 60 and unheated section 58 are made from the same piece of tubing or pipe, thereby being free of couplings and joints where plugs can get hung-up and block flow through fluid line 41. Conduit 54 may be made of flexible or rigid components. Additionally, in various embodiments, heated section 60 and unheated section 58 may be coated with a lining that has a low coefficient of friction that also facilitates pushing of the plug through thermal break 24. In one embodiment, the coefficient of friction for conduit 54 is lower than the coefficient of friction for heat exchanger 22. In one particular embodiment, conduit 54 comprises a stainless steel tube coated with a polytetrafluoroethylene (PTFE) lining

In one embodiment, heating device 56 comprises a resistive heat tape wound around conduit 54. However, any suitable heating device may be used. Heating device 56 can be configured to apply constant heating along its entire length, or can apply different amounts of heating in different zones along its length. This can be done by placing a single heating device along the length of heated section 60, or by placing multiple heating devices with the same or different wattages at different locations along heated section 60, respectively. Alternatively, a single heating device may be fabricated to produce zones with different amounts of heating, such as by using resistive heat tape with varying diameters or thicknesses. In various embodiments, one or more heating devices 56 are used to produce higher amounts of thermal energy near heat exchanger 22 than near unheated section 58. Heating device 56 need not provide sufficient heating to activate the hot melt adhesive liquid, but does provide sufficient heating to allow solidified hot melt adhesive material to return to a flowable liquid state. Thereafter, heat exchanger 22 provides thermal energy and mixing required to activate any liquid hot melt adhesive that may have been insufficiently or partially activated or mixed.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A method of dispensing a hot melt adhesive material, the method comprising:
pumping a hot melt adhesive material in a lower temperature flowable non-molten liquid state into a supply conduit;
passing the hot melt adhesive material through a heated thermal break in the supply conduit that allows free flowing movement of transitional non-molten and molten state material;
heating the hot melt adhesive material in a heat exchanger connected to the heated thermal break to a higher temperature molten liquid state; and
dispensing the hot melt adhesive material in the higher temperature molten liquid state from a dispenser in fluid communication with the heat exchanger.

2. The method of claim 1 and further comprising:
applying heat to the heated thermal break with a heating device separate from the heat exchanger.

3. The method of claim 2 and further comprising:
heating up a solidified transitional non-molten and molten state hot melt adhesive plug within the heated thermal break to partially melt the plug;
flowing the partially melted plug toward the heater exchanger; and
completely melting the plug within the heated thermal break before the plug reaches the heater exchanger.

4. The method of claim 3 and further comprising:
sliding the partially melted plug along an interior of the heated thermal break that is coated with a material having a lower coefficient of friction than that of the heat exchanger.

5. The method of claim 1 wherein the heated thermal break provides a gradient heat profile along the supply line.

6. The method of claim 5 wherein the heated thermal break produces zones having different heat levels along the supply line.

7. The method of claim 6 wherein the thermal break produces zones that are hotter near the heat exchanger than zones upstream from the heat exchanger.

8. The method of claim 1 wherein the heated thermal break includes a liner having a lower coefficient of friction than that of the heat exchanger.

9. The method of claim 1 wherein the supply line smoothly transitions through the heated thermal break.

10. The method of claim 1 wherein the heat exchanger comprises an in-line heater having a mixer.

11. The method of claim 1 wherein the dispenser comprises a heated dispense valve having an orifice.

12. A dispensing system for hot melt adhesive material, the dispensing system comprising:
a pump for pumping hot melt adhesive material in a non-molten liquid state;
a fluid line for receiving hot melt material from the pump;
a heat exchanger for heating the hot melt adhesive to a molten liquid state;
a heated thermal break disposed in the fluid line proximate the heat exchanger to allow free flowing movement of transitional non-molten liquid state and molten liquid state material before entering the heat exchanger; and
a dispenser for receiving molten liquid state hot melt material from the heat exchanger.

13. The dispensing system of claim 12 wherein the fluid line and the heated thermal break have a common inner diameter.

14. The dispensing system of claim 13 wherein the heated heat break and the fluid line smoothly transition into each other.

15. The dispensing system of claim 12 wherein the heated thermal break comprises a portion of the fluid line having a heating element.

16. The dispensing system of claim 15 wherein the heating element produces a temperature gradient across the heated thermal break.

17. The dispensing system of claim 15 wherein the heating element produces zones in the fluid lines that are hotter near the heat exchanger than zones near the pump.

18. The dispensing system of claim 12 wherein the heated thermal break includes a liner having a lower coefficient of friction than that of the heat exchanger.

19. The dispensing system of claim 12 wherein the heated thermal break comprises:
a length of stainless steel hose;
a resistive heating element disposed outside the length of stainless steel hose; and
a polytetrafluoroethylene (PTFE) lining disposed inside the length of stainless steel hose.

20. The dispensing system of claim 12 wherein the heat exchanger includes a mixer.

21. The dispensing system of claim 12 wherein:
the pump comprises a pneumatic piston pump; and
the dispenser comprises a pneumatic dispense valve having an orifice.
